(19) United States
(12) Patent Application Publication
(10) Pub. No.: US 2019/0003677 A1
(43) Pub. Date: Jan. 3, 2019

(54) LIGHT DEVICE, ESPECIALLY A SIGNAL LAMP FOR MOTOR VEHICLES

(71) Applicant: Varroc Lighting Systems, s.r.o., Senov u Noveho Jicina (CZ)

(72) Inventors: Tomas Gloss, Vitkov (CZ); Vit Simurda, Novy Jicin (CZ); Ludek Mazal, Tisek (CZ)

(21) Appl. No.: 16/021,592

(22) Filed: Jun. 28, 2018

(30) Foreign Application Priority Data
Jul. 3, 2017 (CZ) PV 2017-391

(51) Int. Cl. F21S 43/239; G02B 5/02; F21S 43/20; G02B 27/09; G02B 5/20

(52) U.S. Cl. CPC F21S 43/239; G02B 5/0273; G02B 5/20; G02B 27/0955; F21S 43/255

(57) ABSTRACT

The light device, especially a signal lamp for motor vehicles, comprises a translucent front cover (1), a lighting unit (4) with at least one source (41) for emitting of light rays, and an optical element (11) that is adapted for diffusing and/or directing and/or changing the color spectrum of light rays. The optical element (11) is fixed to the cover (1) and the lighting unit (4) is, with the use of a connecting means (6), connected to the cover (1) and/or to at least one projection (1d) the cover (1) is fitted with.

### RELATED APPLICATIONS

This application claims the priority benefit of Czech Patent Application Serial No. PV 2017-391 entitled “A LIGHT DEVICE, ESPECIALLY A SIGNAL LAMP FOR MOTOR VEHICLES,” filed Jul. 3, 2017, the entire disclosure of which is incorporated herein by reference.

### FIELD OF THE INVENTION

The invention relates to a light device, especially a signal lamp, for motor vehicles, comprising a translucent cover and at least one lighting unit with at least one light source to emit light rays.

### BACKGROUND INFORMATION

A lamp, especially for motor vehicles, contains multiple lighting units wherein each of these lighting units provides a different light function or contributes to ensuring the required emission characteristic of the light trace. Individual lighting units are generally mounted in a shaped carrying housing of the lamp while each unit contains at least one light source and other optical elements. The light source emits light rays and the optical elements represent a system of refractive and reflective surfaces and interfaces of optical environments that influence the direction of light rays within the creation of the output light trace. With the use of optical components, e.g. by means of a filter with a microstructure, or with the use of a suitable array of optical elements, high homogeneity, or a 3D effect of the output light beam can be achieved.

The documents U.S. Pat. No. 6,520,669B1 and US20040223328A1 disclose lighting units comprising a flexible substrate on which light sources are mounted in the form of light-emitting semiconductor devices. The light sources are connected to flexible conductive paths created on the flexible substrate so that electric current can be selectively provided to supply the light sources. The flexible substrate is adapted in such a way as to make it possible to integrate the lighting unit in a light device. Flexible lighting units make it possible to create a thin installation. The document EP2853803A1 discloses a simplified design of a light device with a reduced number of components and lower installation requirements. A disadvantage of the prior art is the fact that the arrangement of individual components brings certain installation requirements. Thus, in light devices using standard optical elements, ultra-thin installation cannot be achieved while achieving high homogeneity or a spatial light effect at the same time. Also, the lighting unit cannot be installed at the very edge of the light device because this is the place where the outer covering glass and the carrier housing are connected, usually welded.

The object of the invention is to design a light device, especially a signal lamp for motor vehicles that has low requirements for integration into the vehicle body, makes it possible to create spatial light patterns or meet other design requirements for the output light beam and at the same time enables installation of the lighting unit at the very edge of the light device.

### SUMMARY OF THE INVENTION

The above-mentioned objects of the invention are fulfilled by a light device, especially a signal lamp for motor vehicles comprising a translucent front cover, a lighting unit with at least one source for emitting of light rays, and an optical element that is adapted for diffusing and/or directing and/or changing the color spectrum of light rays. The optical element is fixed to the cover and the lighting unit is, with the use of a connecting means, connected to the cover or to at least one projection the cover is fitted with.

In one of preferred embodiments, the lighting unit is, with the use of a connecting means, connected to at least one arm of the cover protruding from the front part of the cover into the light device.

In another one of preferred embodiments, the lighting unit is, with the use of a connecting means, connected to at least one projection protruding from the cover into the light device.

In another one of preferred embodiments, the lighting unit is positioned between two arms of the cover or between two said projections, or between one arm of the cover and one projection, and it is connected to them with the use of a connecting means.

In another one of preferred embodiments, the lighting unit is, with the use of a connecting means, connected to at least one arm of the cover or to a projection, and to an optical element.

The projection is preferably made together with the cover in such a way that it forms an integral part with it.

The connecting means is preferably filling that the lighting unit is at least partly embedded in.

In another one of preferred embodiments, the connecting means is filling wherein the source and the carrier of the source of the lighting unit are embedded while this filling also fills the space between the lighting unit and the optical element which is not occupied by other parts.

In one of preferred embodiments, the optical element is situated on the inner surface of the front part of the cover.

In another one of preferred embodiments, the optical element is connected to the lateral edge of the cover so that the front surface of the optical element is the front surface of the light device at the same time.

The said filling is preferably based on resin, epoxide, silicone or polyurethane.

In one of preferred embodiments, the distance from the at least one light source to the level of the front surface of the cover is in the range from 2 mm to 20 mm.

The optical segment is preferably made together with the cover in such a way that it forms an integral part with it.

The optical segment is preferably a filter and/or lens and/or array of lenses and/or foil with an optical structure.

In one of preferred embodiments, the light device comprises an optical member situated between the lighting unit and the optical segment.

The optical member is preferably attached with the use of a supplementary optical means to the optical segment and/or cover and/or connecting means.

The optical member is preferably a light guide.

The supplementary connecting means and the connecting means can be preferably made of the same material.

In one of preferred embodiments, at least some of the light sources are LED chips attached to a flexible foil, made especially from PC, PET or PMMA, which conductive paths are also printed on, or to a printed-circuit board (PCB) that is also fitted with conductive paths.

In one of preferred embodiments, the translucent cover is divided into several adjacent sections, at least one said lighting unit and said optical segment being associated with each of them.

In one of preferred embodiments, the cover is composed of several mutually connected parts.

### BRIEF OVERVIEW OF DRAWINGS

The invention will be clarified in a more detailed way with the use of embodiment examples with references to attached drawings, where:

FIG. 1 schematically shows a prior-art design of a light device,

FIG. 2 shows an example of the appearance of a light device according to the invention in the front view,

FIG. 3 shows a detail of the structure according to the first embodiment example of a light device according to the invention in a section along a vertical plane,

FIG. 4 shows a detail of the structure according to the second embodiment example of a light device according to the invention in a section along a vertical plane,

FIG. 5 shows a detail of the structure according to the third embodiment example of a light device according to the invention in a section along a vertical plane,

FIG. 6 shows a detail of the structure according to the fourth embodiment example of a light device according to the invention in a section along a vertical plane,

FIG. 7 shows a detail of the structure according to the fifth embodiment example of a light device according to the invention in a section along a vertical plane,

FIG. 8 shows a detail of the structure according to the sixth embodiment example of a light device according to the invention in a section along a vertical plane, and

FIG. 9 shows a detail of the structure according to the seventh embodiment example of a light device according to the invention in a section along a vertical plane.

### EXAMPLES OF EMBODIMENTS OF THE INVENTION

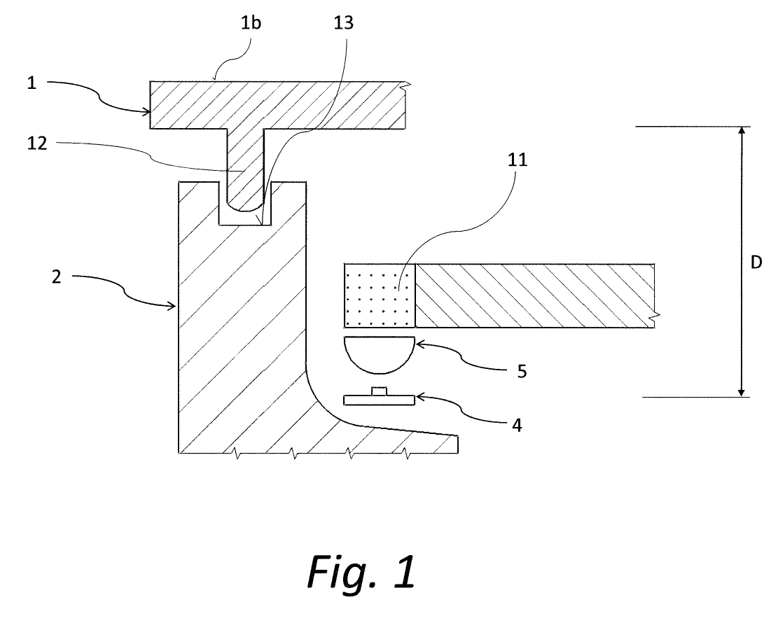

FIG. 1 shows a known embodiment of a signal lamp that comprises a carrier housing 2 covered by a translucent cover 1 to create an inner chamber 3 wherein, at a certain distance from the carrier housing 2, and at a certain distance from the cover 1, a lighting unit 4 is mounted, which is adapted to generate light rays by means of other optical elements 5. The housing 2 and the cover 1 are fitted with a mating welding fin 12 and welding groove 13 enabling mutual connection of the housing 2 and cover 1 by welding. Such an arrangement enables the smallest possible installation depth of approx. 20-25 mm at the edge of the light device while the lighting unit 4 must be in the distance of approx. 5 mm to 7 mm from the outer edge of the light device.

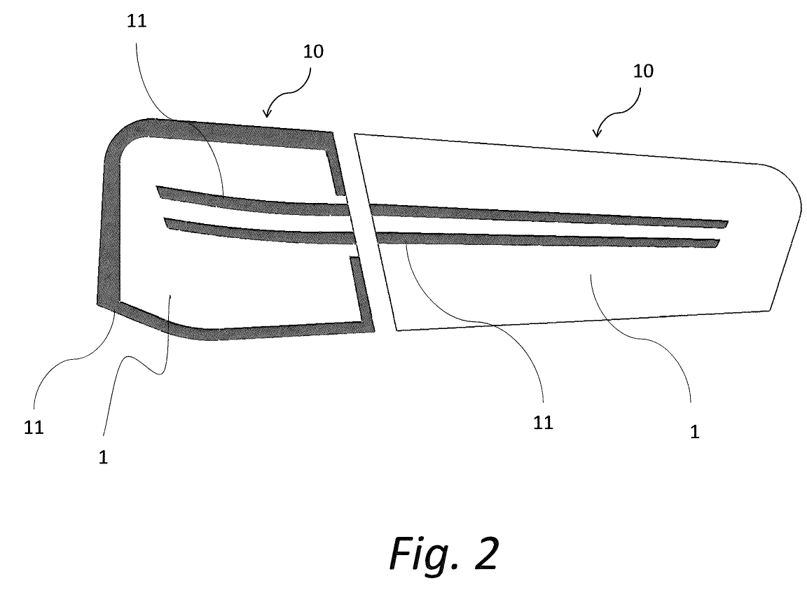

FIG. 2 shows an example of the appearance of a light device according to the present invention in a front view. The inventive light device comprises a translucent cover 1 that comprises two sections 10 of the translucent cover 1 arranged next to each other. The translucent cover 1 of each section 10 is fitted with an optical segment 11 in certain places consisting e.g. of a filter, lens, array of lenses, foil with an optical structure etc. The optical segment 11 is in contact with the translucent cover 1, being adapted to diffuse and/or direct light rays and/or to change the color spectrum of the light rays generated by the lighting unit 4, which is not shown here. The design is adapted to ensure an output light characteristic of the light beam designed especially for the rear red clearance lamp. Unlike the prior art, the solution based on the invention, the design of which is described in a more detailed way below with the use of embodiment examples, makes it possible for the lighting unit 4 to be incorporated up to the entire edge of the cover 1, which enables emitting of light rays through the outwardly oriented edge of a section 10 of the cover 1 as well.

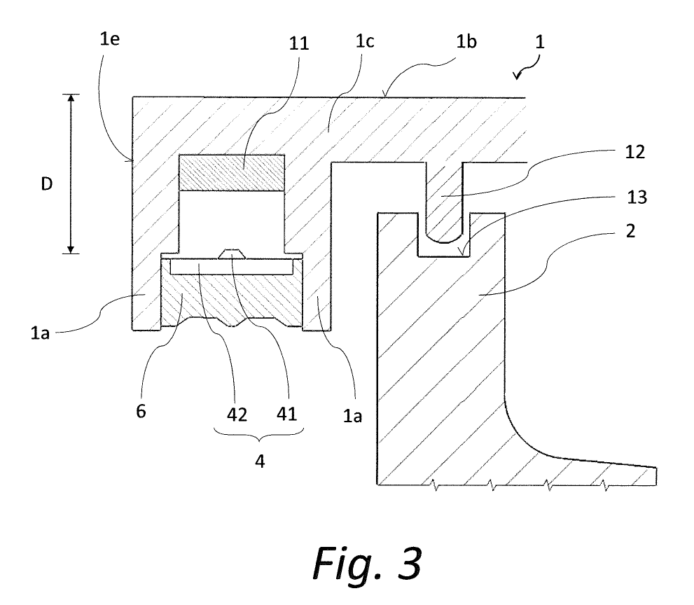

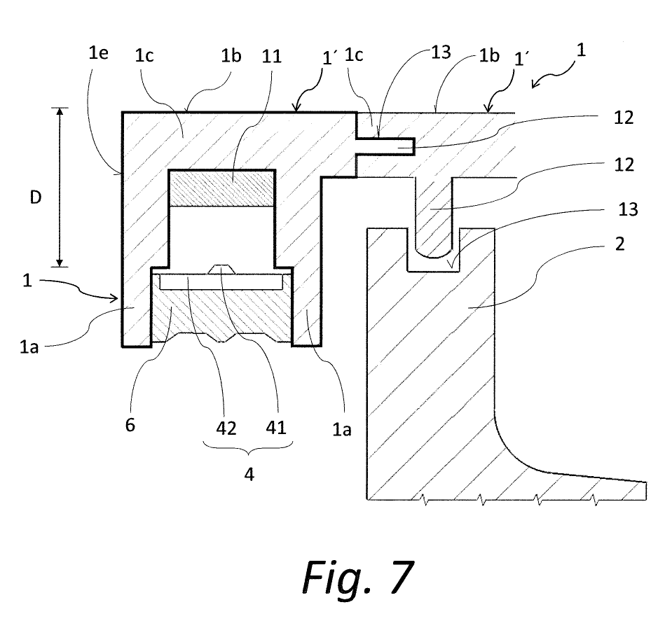

FIG. 3 shows the first embodiment of the light device in accordance with the invention. If the light device preferably consists of several sections 10 (as e.g. in the solution of FIG. 2), FIG. 3 shows the internal arrangement within a section 10 of the cover 1. The solution according to FIG. 3 envisages that the cover 1 comprises inwardly oriented arms 1a that protrude from the front part 1c of the cover 1. So, the arms 1a are an integral part of the cover 1 and are made from the same material as the other parts of the cover 1. Here, it is suitable to make a short digression and point out that the invention generally also envisages such a solution that instead of an arm or arms 1a, the cover 1 can be fitted with a projection or projections 1d (see e.g. FIG. 7) that can be generally made from any suitable material and thus need not be made from the material the cover 1 is made from and are not part of the cover 1, and these projections 1d will be connected to the cover 1 in a suitable way. This connection may be implemented in such a way that the cover 1 and the projections 1c will form an integral form together and they can be e.g. produced by means of multiple injection molding.

Now, to get back to the example of FIG. 3. The lighting unit 4, attached to the free ends of the arms 1a with the use of the connecting means 6, comprises a light source 41 and an optical segment 11, e.g. a filter, is arranged between it and the front part of the cover 1. However, the optical segment 11 can be advantageously an integral part of the cover 1. The optical segment 11 also advantageously fulfills an aesthetic function as it impedes visibility of some optical components as the light sources 41 and the carrier 42 of the light sources 41 of the lighting unit 4 in a view of the internal space of the light device. The translucent cover 1 and the lighting unit 4 are connected to each other with the use of the connecting means 6, preferably a fluid one, ensuring preferably hermetic enclosure of the inner chamber 3 and a stable position of the lighting unit 4. The connecting means 6 can be e.g. based on resin or on silicone adhesive while the connecting element 6 has suitable physical and mechanical properties after the setting, e.g. that the connection should be resistant to vibrations and fatigue, to UV radiation, to higher temperatures etc. Such an arrangement makes it possible to install the lighting unit 4 up to the very edge of the light device and minimize the distance D between the light source 41 and the front surface 1b of the cover 1, which is in the range between 2 mm and 30 mm in a preferred embodiment. Although FIG. 3 also shows a carrier housing 2 connected to the cover 1 with the use of a welding fin 12 and a welding groove 13, as indicated in the previous description, the carrier housing 2 is not an essential part of the design based on the invention because according to the invention its necessary function does not consist in fixing the lighting unit 4, which is attached to the cover 1 instead.

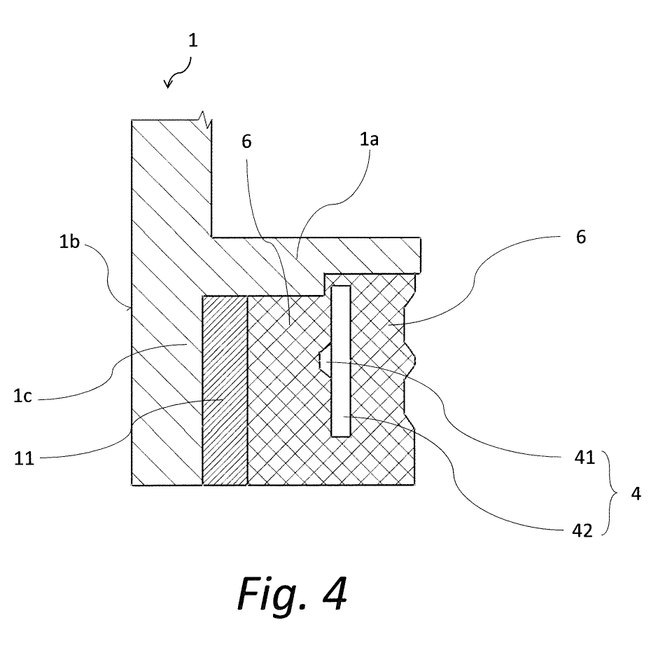

FIG. 4 shows the second embodiment of the inventive solution, which differs from the above-described first embodiment especially in that the cover 1 only comprises one arm 1a for fixing the lighting unit 4, the space between the optical segment 11 and light source 41 being completely filled by the connecting means 6. The connecting means 6 can be transparent, milky or colored and its exemplary material properties and composition have been discussed above. As seen in FIG. 4, the lateral edge of the light device is formed by the edge of the optical element 11 and edge of the optical means 6 in the location under the cover 1.

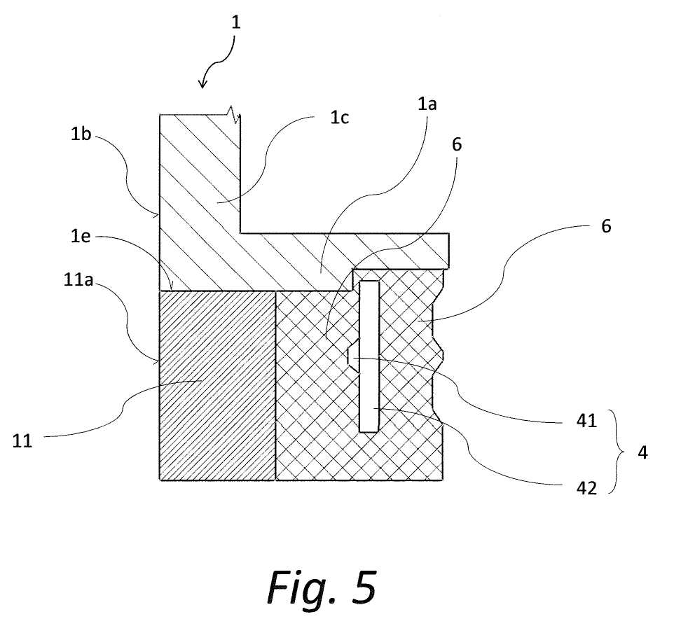

FIG. 5 shows the third embodiment of the invention. The optical segment 11, preferably in the form of a filter, is connected to the lateral edge 1e of the cover 1 and can also be preferably designed in such a way that it forms an integral part with the cover 1, e.g. by being produced by means of multiple injection molding. As indicated in FIG. 5, the front surface 11a of the optical element 11 represents a part of the front surface of the light device at the same time.

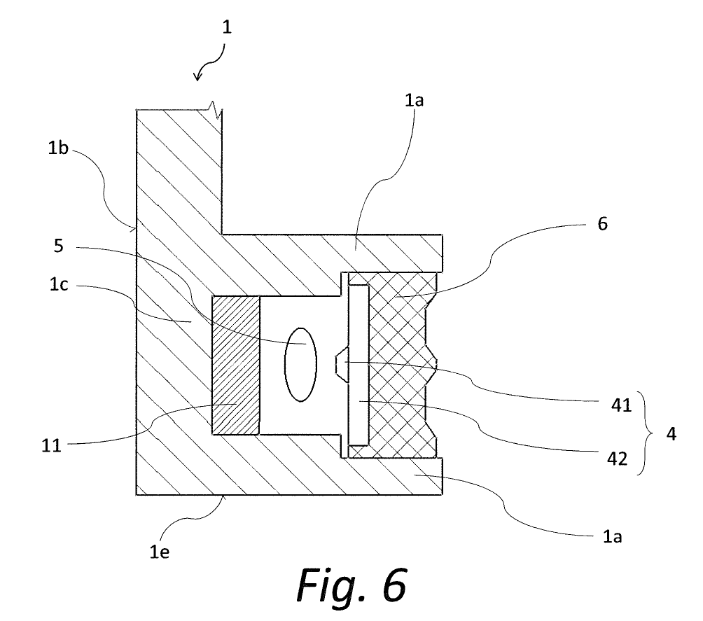

FIG. 6 shows the fourth embodiment of the invention, which differs from the embodiment of FIG. 3 in that between the light source 41 and the optical element 11, an optical member 5 is arranged to ensure the required output characteristic of the light beam.

FIG. 7 shows the fifth embodiment of the light device according to the invention where the light device comprises a cover 1 comprising two parts 1′ connected to each other by means of a welding fin 12 and a welding groove 13.

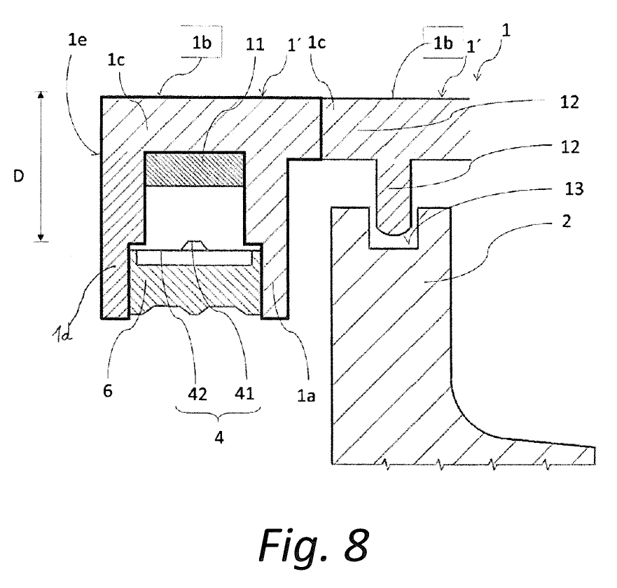

FIG. 8 shows the sixth embodiment of the invention, which differs from the embodiment of FIG. 7 in that one of the parts 1′ of the cover 1, or the cover 1, respectively comprises one arm 1a and is also fitted with one projection 1d, which is produced together with the cover 1 or with its respective part 1′ using the multiple injection molding method. The lighting unit 4 is then attached between the projection 1d and the arm 1a of the cover 1 with the use of a connecting means 6.

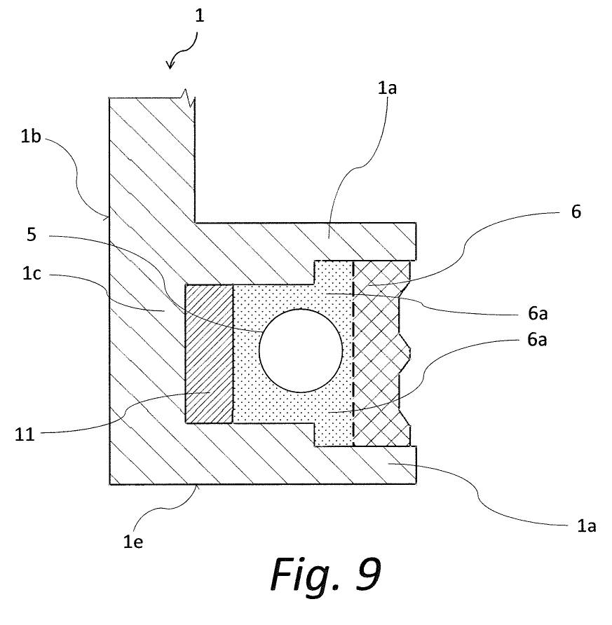

FIG. 9 shows the seventh embodiment of the invention wherein the optical member 5 is designed as a light-guiding part of a selectable cross-section the purpose of which is to distribute light along the shape of the optical element 11 to replace an array of LEDs installed on a PCB or Flexboard. In this case, the lighting unit 4 can be advantageously located in one place only from where light is conducted by the optical member 5. Here, the connecting element 6 has a sealing and fixing function and can be advantageously merged with the supplementary connecting element 6a used to attach the optical member 5. In the particular embodiment, the connecting element 6 and the supplementary connecting element 6a are made of the same material and will have a suitable refraction index to ensure guiding of light in the optical member 5, i.e. close to the value 1. Another variant is that the supplementary connecting elements 6a will not be used and will be replaced with an air gap and the connecting element 6 can then be of any refraction index or color. Another possible variant is that the supplementary connecting element 6a can be implemented as coating applied on the optical member 5 with a suitable refraction index while the connecting element 6 can have any refraction index in this case and will encircle the optical member 5 with the applied coating.

The lighting unit 4 is preferably implemented as a Flexboard, i.e. an array of LED light sources 41 arranged on a carrier 42 with a flexible shape. However, the lighting unit 4 can also be implemented as LED diodes and a standard PCB. The use of planar light sources, OLEDs, flexible OLEDs, OLET (organic light-emitting transistor) can also be considered.

### LIST OF REFERENCE MARKS

1—cover
1′—part of the cover
1a—arm
1b—front surface of the cover
1c—front part of the cover
1d—projection
1e—lateral edge of the cover
2—carrier housing
4—lighting unit
41—source
42—carrier
5—optical member
6—connecting means
6a—supplementary connecting means
10—translucent cover section
11—optical element
11a—front surface of the optical element
12—welding fin
13—welding groove
D—distance

1. A light device comprising a translucent front cover, a lighting unit with at least one source for emitting of light rays, and an optical element that is adapted for diffusing, directing, and/or changing the color spectrum of light rays,
wherein the optical element is fixed to the cover and the lighting unit is, with the use of a connecting means, connected to the cover and/or to at least one projection the cover is fitted with.

2. The light device according to claim 1, wherein the lighting unit is, with the use of the connecting means, connected to one or more arms of the cover protruding from a front part of the cover into the light device and/or to one or more projections protruding from the cover into the light device.

3. The light device according to claim 2, wherein the lighting unit is situated between two arms of the cover, between two projections, or between one arm of the cover and one projection and is connected to them with the use of the connecting means.

4. The light device according to claim 2, wherein the lighting unit is, with the use of the connecting means, connected to:
one or more arms or projections and to the optical element.

5. The light device according to claim 1, wherein the at least one projection is made together with the cover in such a way that the at least one projection forms an integral part with the cover.

6. The light device according to claim 1, wherein the connecting means is a filling in which the lighting unit is at least partly embedded.

7. The light device according to claim 1, wherein the connecting means is a filling in which the source and a carrier of the source of the lighting unit are embedded, wherein the filling also fills a space between the lighting unit and the optical element that is not occupied by other parts.

8. The light device according to claim 1, wherein the optical element is situated on an inner surface of the front part of the cover.

9. The light device according to claim 1, wherein the optical element is connected to a lateral edge of the cover so that a front surface of the optical element is at the same time a front surface of the light device.

10. The light device according to claim 6, wherein the filling comprises a resin, an epoxide, a silicone or a polyurethane.

11. The light device according to claim 1, wherein the distance from a light source to the level of the front surface of the cover is in the range from 2 mm to 30 mm.

12. The light device according to claim 1, wherein the optical segment (11) is made together with the cover (1) in such a way that it forms an integral part with it.

13. (canceled)

14. The light device according to claim 1, further comprising an optical member situated between the lighting unit and the optical element.

15. The light device according to claim 14, wherein the optical member is attached with the use of a supplementary connecting means to the optical element, the cover, and/or the connecting means.

16. The light device according to claim 14, wherein the optical member is a light guide.

17. The light device according to claim 15, wherein the supplementary connecting means and the connecting means are made of the same material.

18. The light device according to claim 1, wherein the source comprises LED chips attached to:
(i) a flexible foil, made from PC, PET or PMMA, which conductive paths are also printed on, or
(ii) a printed-circuit board (PCB) that is also fitted with conductive paths.

19. The light device according to claim 1, wherein the cover is divided into several adjacent sections, wherein at least the lighting unit and the optical element being associated with the adjacent sections.

20. The light device according to claim 1, wherein the cover is composed of a plurality of mutually connected parts of the cover.
